(19) United States
(12) Patent Application Publication
(10) Pub. No.: US 2007/0036642 A1
(43) Pub. Date: Feb. 15, 2007

(54) Bridged inducer

(75) Inventors: Wei-Chung Chen, Westlake Village, CA (US); Khanh C. Hoang, Van Nuys, CA (US); Morgan Williams, Reseda, CA (US); Brian Shinguchi, Woodlands Hills, CA (US); Jeff H. Miller, Simi Valley, CA (US); Willard Cary Clever, Sherman Oaks, CA (US)

Correspondence Address: John S. Beulick;Armstrong Teasdale LLP, Suite 2600, One Metropolitan Square, St. Louis, MO, 63102, US

(73) Assignee: The Boeing Company

(21) Appl. No.: 11/201,018

(22) Filed: Aug. 10, 2005

(51) Int. Cl. F03B 3/12

(52) U.S. Cl. 415/71

(57) ABSTRACT

An inducer comprising a conically configured hub, a plurality of blades projecting from the hub and a bridge that connects a first blade of two adjacent blades of the plurality of blades to a second blade of the plurality of blades. Each blade of the plurality of blades has a helix shape and is configured as an advancing spiral. The bridge that connects the first blade of two adjacent blades of the plurality of blades to a second blade of the plurality of blades has an airfoil configuration. The bridge is attached to the pressure side of the first blade proximate the leading edge of the first blade and to the suction side of the second blade. Alternatively, the airfoil shaped bridge may be attached to the pressure side of the first blade proximate the trailing edge of the first blade.

### BACKGROUND OF THE INVENTION

1. Field of the Invention

The present invention relates in general to pumps and is particularly directed to an improved inducer design for pumps that yield higher performance and longer life.

2. Background

An inducer is one of the main components in rocket engine turbo pumps or industrial pumps. The inducer is characterized by long, narrow, helical rotating passages that provide enough fluid pressure rise to collapse cavitation vapor bubbles before the bubbles can adversely affect the head-rise performance and mechanical integrity of the main pumping stages.

Inducer design has been challenging in the past because it experiences a harsh and dynamic flow environment as the first element/stage in a pumping system. The oscillatory nature of the cavitation vapor bubble collapse and regeneration the inducer experiences can be a source of large dynamic blade loads. By nature of the rotating, profiled blades, the inducer also experiences flow induced and rotation induced structural loads. These loads along with blade natural frequencies have to all be considered in designing an inducer.

Previous inducer configurations, designed to yield higher performance attempt to accomplish this objective by reducing the thickness of blades on an inducer. Reducing overall blade thickness reduces flow area blockage and keeps the blade within fluid cavity height, which helps achieve maximum performance. Reducing the thickness of blade leading edges minimize flow field disturbances and improves the pump hydro-performance in head rise and efficiency. Notwithstanding these performance improvements resulting from reducing the thickness of inducer blades it also lowers the inducer stress safety margin. As a result, the inducer blades may break causing damage.

An alternative to reducing the thickness of inducer blades in order to increase the flow area within an inducer is to increase the distance between the blades, thereby increasing the flow area. While this solution when used in combination with maintaining the thickness of inducer blades can result in improved suction performance, this design solution also has disadvantages. It causes an increase in the axial length of the inducer, resulting in an increase of the pump weight and pump size. This is problematic because, in order to increase the payload of a rocket, the overall size and weight of the rocket engine needs to be reduced.

There is a need for an inducer whereby its configuration unloads the blade stress without compromising the pump hydrodynamic performance and/or pump size and weight. The present invention allows for improved inducer design with better stress margins, lower flow coefficient, higher head coefficient, and higher inducer speed design.

### SUMMARY OF THE INVENTION

Inducers according to the present invention include a hub, a plurality of blades projecting from the hub and a bridge that connects a first blade of the plurality of blades to a second blade of the plurality of blades. Generally, inducers of the type set-forth in the present invention have a hub that has a conical configuration. Each blade of the plurality of blades in the preferred embodiment of the invention, have a helix shape and are configured as an advancing spiral. The bridge that connects the first blade of the plurality of blades to the second blade of the plurality of blades has an airfoil configuration. The bridge is attached to the pressure side of the first blade and to the suction side of the second blade. In one embodiment of the invention, the airfoil shaped bridge is attached to the pressure side of the first blade proximate the leading edge of the first blade. Alternatively, the airfoil shaped bridge may be attached to the pressure side of the first blade proximate the trailing edge of the first blade. An object of the invention is to connect two adjacent blades with the airfoil shaped bridge to provide additional stability to the attached blades so that the attached blades of the plurality of blades projecting from the hub may handle more dynamic loads. It is further contemplated that the bridge be positioned as a connector between two adjacent blades at any point along two adjacent blades where there is a need for reinforcement in order to reduce flow area blockage, change blade frequencies, or increase high cycle fatigue safety factor margin. It is also an object of the present invention to provide a configuration that allows for inducer blades to be more perpendicular to the axis of the hub (low flow coefficient) to increase speed and reduce the size and weight of the pump.

It is to be understood that both the foregoing general description and the following detailed description are exemplary and explanatory only and are not restrictive of the invention as claimed. The numerous objects and advantages of the present inducer may be better understood by those skilled in the art by reference to the embodiments described herein.

### BRIEF DESCRIPTION OF THE DRAWINGS

FIG. 1 is a perspective view of an inducer embodying the present invention;

FIG. 2 is a half sectional view of an inducer embodying the present invention; and

FIG. 3 is a top view of an inducer embodying the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings. The exemplary device described herein may be modified by changing the configuration, shape and or structure of its components. Accordingly, the following detailed description does not limit the invention. Instead, the proper scope of the invention is defined by the appended claims.

Generally the present invention is for an improved inducer design. The improved design of an inducer comprises of a conically configured hub that has a plurality of helix shaped blades extending substantially perpendicular to the axis of the hub. Each blade of the plurality of the helix shaped blades has an advancing spiral configuration. It is also contemplated that the plurality of blades are of an alar configuration. The helix configuration of each blade causes portions of at least two blades to extend parallel to each other for some distance. At a predefined point along the parallel sections of two blades, a bridge, generally configured as a beam, is positioned between and connects the two blades. Each blade has two sides, top and bottom. The bridge connects the topside of a first blade of two blades to the bottom side of a second blade. The bridge acts as a connector between two parallel blades so that each of the parallel blades can handle more dynamic loads. By including the bridge in the inducer design, the inducer blade no longer has to be thickened in order to enable the inducer to support more dynamic loads. This will allow for a more performance optimized inducer design.

Generally, in the preferred embodiment, a bridge is positioned proximate the leading edge of each of blade extending from the hub where dynamic loads are typically very high. However, it is contemplated that a bridge may be placed anywhere along the top and bottom sides of two parallel blades where reinforcement is needed to reduce flow area blockage for improved performance, change blade frequencies to avoid any excitation, or increase the high cycle fatigue safety factor margin by making the adjacent blade act as a system. Inducers of the design set forth herein have a configuration that allow higher levels of performance capabilities while still meeting structural requirements. Inducer designs of the type described herein, which include a bridge, allow inducer configurations in which the inducer blades may be substantially more perpendicular to the axis of the hub (lower flow coefficient) and improve inducer suction performance. Bridge connectors of the type described herein are very thin beams and configured so that there is only a small amount of disturbance. In the preferred embodiment, the bridge has an airfoil shape. It is recognized that the bridge does introduce blockage and thereby interference into the flow area. However, the blockage and disturbance created by the bridge occurs over a very small distance in comparison to prior art designs that enhance blade stability by increasing the blade thickness. When inducer blades are thickened in order to enhance inducer performance capabilities, the flow area is reduced over the entire distance of the blade, causing a reduction in performance. In the present invention, the disturbance caused by the bridge occurs over a very small distance in comparison to thickening of the blade and any performance impact will be very minimal.

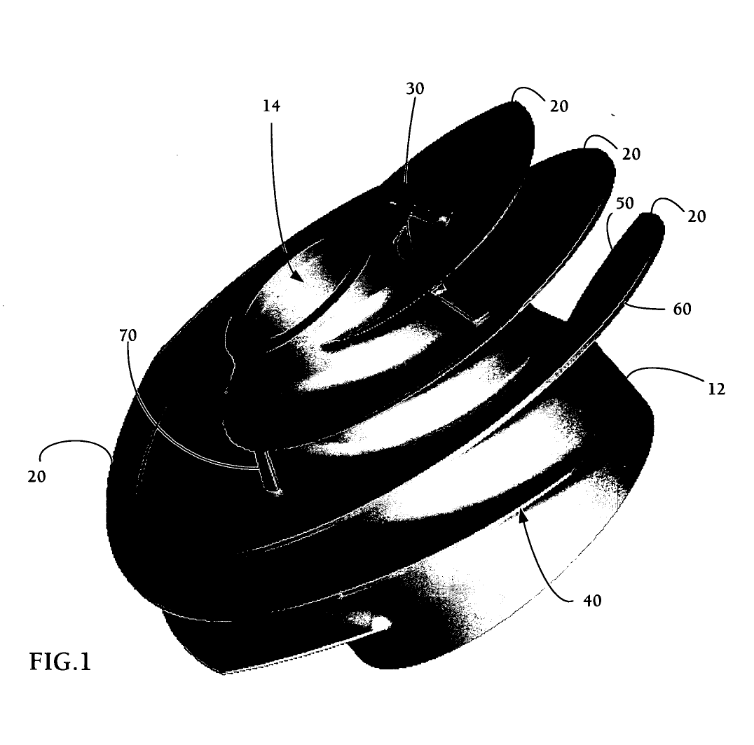

An embodiment of an inducer adapted to include the improved configuration is disclosed in FIGS. 1 through 3. As illustrated in FIG. 1, the inducer 10 comprises of a generally conical body 12 having an axial opening 14, for receiving a drive shaft (not shown) and formed with a plurality of blades 20 projecting outward and substantially perpendicular to the axis of the conical body 12. Each individual blade of the plurality of blades 20 is connected to the next successive blade 20 by a bridge connector 70. As illustrated each of the plurality of blades 20 are helix shaped and configured as an advanced spiral, having a blade leading edge 30 and a blade trailing edge 40. Each blade of the plurality of blades 20 has a top/suction side 50 and a bottom/pressure side 60. The bridge 70 is positioned between two parallel blades of the plurality of blades, and connected to a pressure side 60 of a first blade of the plurality of blades and suction side 50 of a second blade of the plurality of blades.

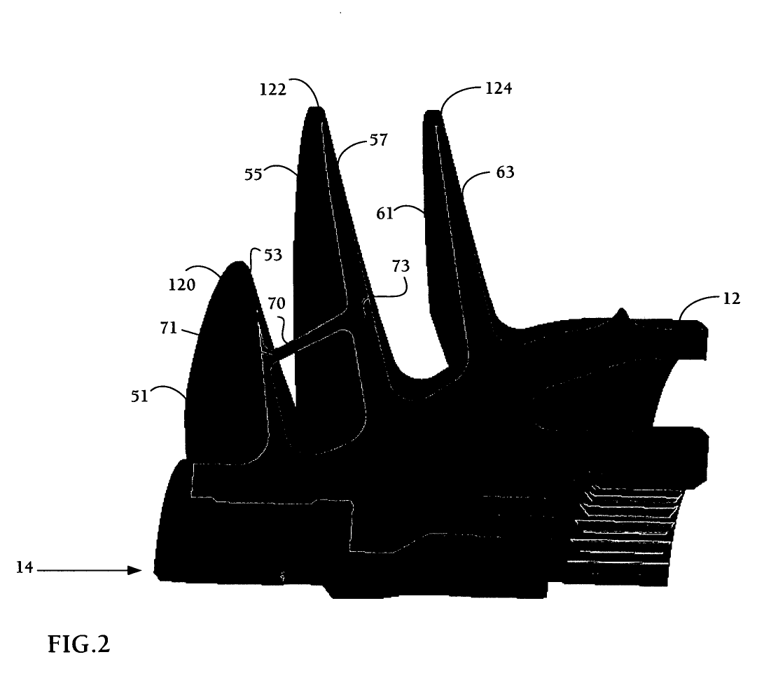

As illustrated in FIG. 2, the inducer 10 has a plurality of blades 120, 122, and 124 projecting from the conical body. First blade 120 extends substantially perpendicular to the axial opening 14 of the conical body 12, and has a blade suction side 51 and a blade pressure side 53. Second blade 122 extends substantially perpendicular to the axial opening 14 of the conical body 12, and has a blade suction side 55 and a blade pressure side 57. Third blade 124 extends substantially perpendicular to the axial opening 14 of the conical body 12, and has a blade suction side 61 and a blade pressure side 63. First blade 120 is attached to blade 122 by bridge 70. Bridge 70 has a first end 71 and a second end 73. The first end 71 of bridge 70 is attached to the blade pressure side 53 of first blade 120. The second end of 73 of bridge 70 is attached to the blade suction side 55 of the second blade 122. Generally, in the present embodiment, the plurality of blades, 120, 122, and 124 projecting from the conical body and extending substantially perpendicular to the axial opening 14, in the present embodiment, extend at an angle between five and ten degrees in relation to the axis of the hub.

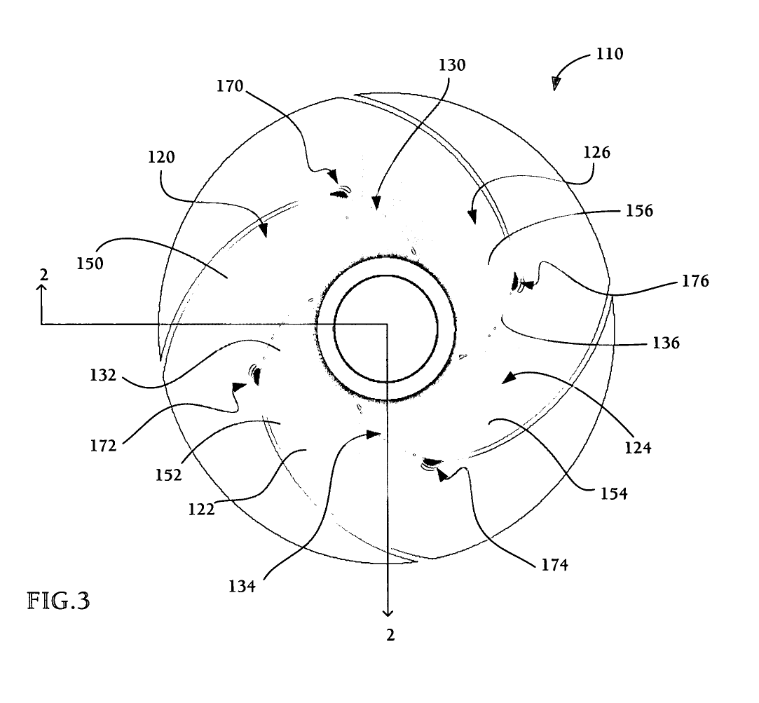

In the embodiment shown in FIG. 3, the inducer 110 is comprised of four helix shaped blades 120, 122, 124, and 126. The first blade 120 is connected to the fourth blade 126 by a first bridge 170. First bridge 170 is attached to the pressure side of the first blade 120 proximate the leading edge 130 of first blade 120. First bridge 170 is also attached to the suction side 156 of the fourth blade 126. The second blade 122 is attached to the first blade 120 by bridge connector 172. Bridge connector 172 is attached to the pressure side of the first blade 122 and the suction side 150 of the first blade 120. Bridge connector 172 is attached to the second blade 122 proximate the leading edge 132 of the second blade 122. The third blade 124 is attached to the second blade 122 by the third bridge connector 174. Third bridge connector 174 is attached to the pressure side of third blade 124 and to the suction side 152 of second blade 122. The third bridge connector 174 is connected to the third blade 124 proximate the third blade leading edge 134. The fourth blade 126 is attached to the third blade 124 by fourth bridge connector 176. Fourth bridge connector 176 is attached to the pressure side of the fourth blade 126 and to the suction side 154 of the third blade 124. The fourth bridge connector 176 is connected to the fourth blade 126 proximate the fourth blade leading edge 136.

While it is not illustrated in FIGS. 1 through 3, in alternative embodiments, the bridge connector of a respective blade of the plurality of blades may be connected anywhere along two parallel blades where support is needed. By way of example, with respect to the embodiment illustrated in FIG. 2, the bridge 70 may be connected to the trailing edge of first blade 120, in order to provide support proximate the trailing edge of blade 120. Alternatively, bridge 70 may be connected to the trailing edge of second blade 122. Bridge 70 would be connected to the trailing edge of the first blade 120 at the pressure side 53 of the first blade 120. Alternatively, the bridge 70 may be connected to the first blade 120 at the pressure side 53 at any point along the pressure side 53 so long as bridge 70 is connected proximate the trailing edge of second blade 122. In this embodiment illustrated in FIG. 2, the second end 73 of the bridge connector 70 would be connected to the suction side 55 of the second blade proximate the trailing edge of the second blade 122.

It is intended, therefore, that the specification and examples be considered as exemplary only, with a true scope and spirit of the invention being indicated by the following claims and their full scope of equivalents.

What is claimed is:

1. An inducer comprising:
a hub;
a plurality of blades projecting from said hub; and
a bridge connecting a first blade of said plurality of blades to a second blade of said plurality of blades.

2. The inducer of claim 1, wherein said hub has a conical shape.

3. The inducer of claim 1, wherein each blade of said plurality of blades is helix shaped.

4. The inducer of claim 1, wherein each blade of said plurality of blades is configured as an advancing spiral.

5. The inducer of claim 1, wherein said bridge has an airfoil configuration.

6. The inducer of claim 1, wherein said bridge has first and second ends, wherein said first end of said bridge is attached to the pressure side of said first blade and said second end of said bridge is attached to the suction side of said second blade.

7. The inducer of claim 6, wherein said first end of said bridge is attached to the pressure side of said first blade proximate the leading edge of said first blade.

8. The inducer of claim 6, wherein said first end of said bridge is attached to the pressure side of said first blade proximate the trailing edge of said first blade.

9. The inducer of claim 6, wherein said second end of said bridge is attached to the suction side of said second blade proximate the trailing edge of said second blade.

10. The inducer of claim 6, wherein said second end of said bridge is attached to the suction side of said second blade proximate the leading edge of said second blade.

11. The inducer of claim 1, wherein said plurality of blades extend substantially perpendicular from said hub.

12. The inducer of claim 1, wherein said plurality of blades extends from said hub at an angle approximately between five and ten degrees in relation to the axis of said hub.

13. An inducer comprising:
a conical configured hub;
a plurality of blades being formed of an alar configuration and projecting substantially perpendicular from said hub; and
a bridge connecting a first blade of said plurality of blades to a second blade of said plurality of blades, wherein said bridge has an airfoil configuration.

14. The inducer of claim 13, wherein said bridge has first and second ends, wherein said first end of said bridge is connected to said pressure side of said first blade and said second end of said bridge is connected to said suction side of said second blade.

15. The inducer of claim 14, wherein first end of said bridge is connected to the pressure side of said first blade proximate the leading edge of said first blade.

16. The inducer of claim 14, wherein said first end of said bridge is connected to the pressure side of said first blade proximate the trailing edge of said first blade.

17. The inducer of claim 14, wherein said second end of said bridge is connected to the suction side of said second blade proximate the trailing edge of said second blade.

18. The inducer of claim 14, wherein said second end of said bridge is connected to the suction side of said second blade proximate the leading edge of said second blade.

19. The inducer of claim 13, wherein said plurality of blades extends from said hub at an angle approximately between five and ten degrees in relation to the axis of said hub.

20. A method of increasing the dynamic load capacity of a plurality of blades of an inducer comprising the following step:
attaching a first blade and a second blade of the plurality of blades with a bridge, wherein the first blade and the second blade are adjacent.
